(19) United States
(12) Patent Application Publication
(10) Pub. No.: US 2026/0080863 A1
(43) Pub. Date: Mar. 19, 2026

(54) Low Footprint Streaming Keyword Spotting for Custom Phrases

(71) Applicant: Google LLC, Mountain View, CA (US)

(72) Inventors: Pai Zhu, New York City, NY (US); Jacob William Bartel, San Francisco, CA (US); Hyun Jin Park, Palo Alto, CA (US); Kurt Partridge, San Francisco, CA (US)

(73) Assignee: Google LLC, Mountain View, CA (US)

(21) Appl. No.: 18/889,989

(22) Filed: Sep. 19, 2024

(51) Int. Cl. G10L 15/06; G10L 15/08; G10L 15/16

(52) U.S. Cl. CPC G10L 15/063; G10L 15/16; G10L 2015/088

(57) ABSTRACT

A method includes receiving a plurality of sets of utterances. Each respective set of utterances includes audio data samples of a corresponding utterance different than the corresponding utterance of each other set of utterances of the plurality of sets of utterances. For a respective one of the sets of utterances, the method includes determining a keyword enrollment embedding for an enrollment subset of the audio data samples of the respective one of the sets of utterances and determining a corresponding matching keyword test embedding for each respective audio data sample of a test subset of the audio data samples of the respective one of the sets of utterances. The method also includes determining a corresponding nonmatching keyword test embedding for each respective audio data sample of each of the other sets of utterances. The method also includes training a keyword detection model to detect a presence of a custom keyword.

### TECHNICAL FIELD

This disclosure relates to low footprint streaming keyword spotting for custom phrases.

### BACKGROUND

In speech-enabled environments, such as a home, automobile, or schools, users may speak a query or command and a digital assistant may answer the query and cause commands to be performed. In some scenarios, users must precede the spoken query or command with a keyword in order for the digital assistant to process the query or command. The use of keywords prevents the digital assistants from needlessly processing background sounds and speech that are not directed towards the digital assistant. Yet, if a keyword is spoken and not detected, the query or command will not be executed. As digital assistants become more personalized, there is a growing demand to allow users to specify their own customized keywords. Enabling the use of customized keywords increases the number of keywords, and thus, also increases the complexity for digital assistants in accurately detecting keywords spoken by users.

### SUMMARY

One aspect of the disclosure provides a computer-implemented method that when executed on data processing hardware causes the data processing hardware to perform operations for training a keyword detection model to detect custom phrases. The operations include receiving a plurality of sets of utterances. Each respective set of utterances includes audio data samples of a corresponding utterance different than the corresponding utterance of each other set of utterances of the plurality of sets of utterances. For a respective one of the set of utterances, the operations include determining a keyword enrollment embedding for an enrollment subset of the audio data samples of the respective one of the set of utterances and determining a corresponding matching keyword test embedding for each respective audio data sample of a test subset of the audio data samples of the respective one of the set of utterances. For each respective audio data sample of each other set of utterances, the operations include determining a corresponding nonmatching keyword test embedding. The operations also include training a keyword detection model to detect a presence of a custom keyword in spoken audio based on the keyword enrollment embedding, the corresponding matching keyword test embedding determined for each respective audio data sample of the test subset, and the corresponding nonmatching keyword test embedding determined for each respective audio data sample of each other set of utterances.

Implementations of the disclosure may include one or more of the following optional features. In some implementations, determining the keyword enrollment embedding for the enrollment subset of the audio data samples includes determining a corresponding keyword enrollment embedding for each respective audio data sample of the enrollment subset and determining a centroid keyword enrollment embedding based on the corresponding keyword enrollment embedding determined for each respective audio data sample of the enrollment subset. Training the keyword detection model may include minimizing a first loss between the keyword enrollment embedding and the corresponding matching keyword test embedding determined for each respective audio data sample of the test subset. Training the keyword detection model may include maximizing a second loss between the keyword enrollment embedding and the corresponding nonmatching keyword test embedding determined for each respective audio data sample of each other set of utterances.

In some examples, the audio data samples include at least one of non-synthetic audio data samples or synthetic audio data samples. Each audio data sample of the respective one of the set of utterances includes speech characteristics speaking the corresponding utterance different than at least one other audio data sample of the respective one of the set of utterances. In some implementations, for the respective one of the set of utterances, the operations further include assigning one or more audio data samples from the respective one of the set of utterances to the enrollment subset and assigning each other audio data sample from the respective one of the set of utterances not assigned to the enrollment subset to the test subset. The corresponding utterance of each respective set of utterances may include a user-defined custom keyword. In some examples, determining the keyword enrollment embedding includes determining the keyword enrollment embedding using an encoder of the keyword detection model and determining the corresponding matching keyword test embedding includes determining the corresponding matching keyword test embedding using the encoder of the keyword detection model. In these examples, the encoder includes a conformer encoder.

Another aspect of the disclosure provides a system that includes data processing hardware and memory hardware storing instructions that when executed on the data processing hardware causes the data processing hardware to perform operations. The operations include receiving a plurality of sets of utterances. Each respective set of utterances includes audio data samples of a corresponding utterance different than the corresponding utterance of each other set of utterances of the plurality of sets of utterances. For a respective one of the set of utterances, the operations include determining a keyword enrollment embedding for an enrollment subset of the audio data samples of the respective one of the set of utterances and determining a corresponding matching keyword test embedding for each respective audio data sample of a test subset of the audio data samples of the respective one of the set of utterances. For each respective audio data sample of each other set of utterances, the operations include determining a corresponding nonmatching keyword test embedding. The operations also include training a keyword detection model to detect a presence of a custom keyword in spoken audio based on the keyword enrollment embedding, the corresponding matching keyword test embedding determined for each respective audio data sample of the test subset, and the corresponding nonmatching keyword test embedding determined for each respective audio data sample of each other set of utterances.

Implementations of the disclosure may include one or more of the following optional features. In some implementations, determining the keyword enrollment embedding for the enrollment subset of the audio data samples includes determining a corresponding keyword enrollment embedding for each respective audio data sample of the enrollment subset and determining a centroid keyword enrollment embedding based on the corresponding keyword enrollment embedding determined for each respective audio data sample of the enrollment subset. Training the keyword detection model may include minimizing a first loss between the keyword enrollment embedding and the corresponding matching keyword test embedding determined for each respective audio data sample of the test subset. Training the keyword detection model may include maximizing a second loss between the keyword enrollment embedding and the corresponding nonmatching keyword test embedding determined for each respective audio data sample of each other set of utterances.

In some examples, the audio data samples include at least one of non-synthetic audio data samples or synthetic audio data samples. Each audio data sample of the respective one of the set of utterances includes speech characteristics speaking the corresponding utterance different than at least one other audio data sample of the respective one of the set of utterances. In some implementations, for the respective one of the set of utterances, the operations further include assigning one or more audio data samples from the respective one of the set of utterances to the enrollment subset and assigning each other audio data sample from the respective one of the set of utterances not assigned to the enrollment subset to the test subset. The corresponding utterance of each respective set of utterances may include a user-defined custom keyword. In some examples, determining the keyword enrollment embedding includes determining the keyword enrollment embedding using an encoder of the keyword detection model and determining the corresponding matching keyword test embedding includes determining the corresponding matching keyword test embedding using the encoder of the keyword detection model. In these examples, the encoder includes a conformer encoder.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are schematic views of an example system having a speaker verification system and a keyword detector.

FIGS. 2A and 2B are schematic views of the speaker verification system of FIGS. 1A and 1.

FIG. 3 is a schematic view of an example training process for training the multilingual speaker verification system.

FIG. 4 is a schematic view of an example conditioning process for conditioning the keyword detector from FIGS. 1A and 1B.

FIG. 5 is a schematic view of an example training process for training the keyword detector.

FIG. 6 is a flowchart of an example arrangement of operations for a method of training a keyword detection model to detect custom phrases.

FIG. 7 is a schematic view of an example computing device that may be used to implement the systems and methods described herein.

Like reference symbols in the various drawings indicate like elements.

### DETAILED DESCRIPTION

Keyword spotting enables speech recognition systems to avoid unnecessary processing of speech that is not directed towards speech-enabled devices and other background noises. In particular, keyword or hotword spotting requires users to precede voice commands or queries with a particular keyword such as “Hey Google” or “Ok Google.” As such, speech recognition systems will not process received audio data unless a keyword detector detects the predetermined keyword. Typically, these keyword models are trained on hundreds, thousands, or even millions of hours of speech in order to accurately detect the keywords in audio. As devices become more intelligent and personalized, there is a growing demand from customers for the flexibility to specify personal keywords via text or audio.

For example, a user may want to personalize their device to respond to the user-defined keyword of “Hey device” rather than a generic keyword of “Hey Google.” Thus, in this example, the user may provide the user-defined keyword to the device by textually inputting (e.g., via a keyboard) the user-defined keyword and/or speaking the user-defined keyword one or more times during an enrollment process. Notably, however, current training approaches of keyword models do not accurately replicate such enrollment process. That is, during training the keyword models may train on hundreds or thousands of training utterances for a particular keyword. Yet, in the user-defined keyword scenario, the user may only speak the user-defined keyword one or more times. Thus, when the user-defined keyword is not included in the training data, the keyword model may have only seen the user-defined keyword once in contrast to the hundreds of other keywords seen during training.

To that end, implementations herein are directed towards a training process that includes receiving a plurality of sets of utterances. Each respective set of utterances includes audio data samples of a corresponding utterance different than the corresponding utterance of each other set of utterances of the plurality of sets of utterances. That is, each set of utterances may include audio data of a particular keyword that is different than the particular keyword of each other set of utterances. Moreover, each audio data sample of the corresponding utterance may include different speech characteristics than the other audio data samples in the same set of utterances. For a respective one of the sets of utterances, the training process includes determining a keyword enrollment embedding for an enrollment subset of the audio data samples of the respective one of the sets of utterances and determining a corresponding matching keyword test embedding for each respective audio data sample of a test subset of the audio data samples of the respective one of the set of utterances. For each respective audio data sample of each of the other sets of utterances (e.g., the sets of utterances other than the respective one of the set of utterances), the training process includes determining a corresponding nonmatching keyword test embedding. The training process also includes training a keyword detection model to detect a presence of a custom keyword in spoken audio based on the keyword enrollment embedding, the corresponding matching keyword test embedding determined for each respective audio data sample of the test subset, and the corresponding nonmatching keyword test embedding determined for each respective audio data sample of each of the other sets of utterances.

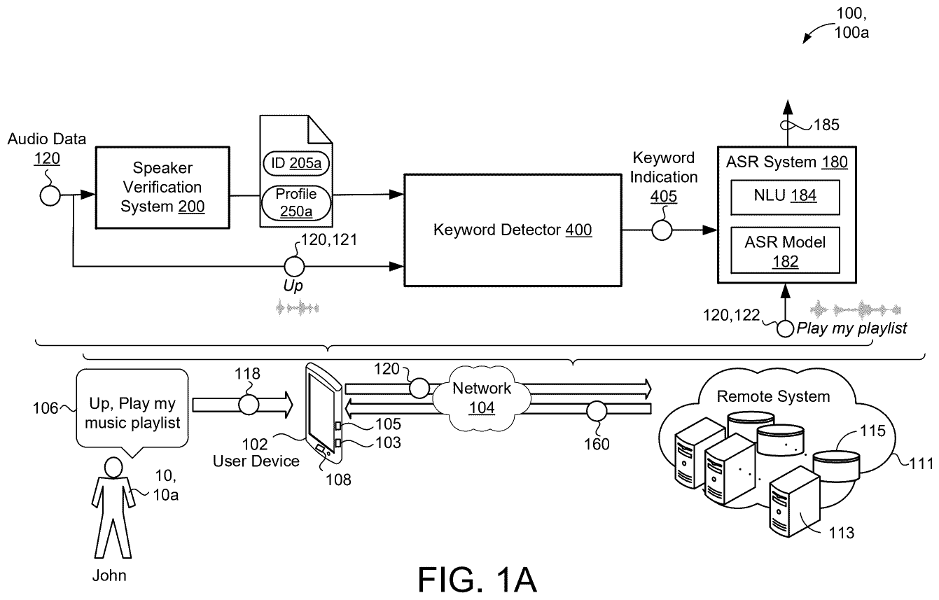

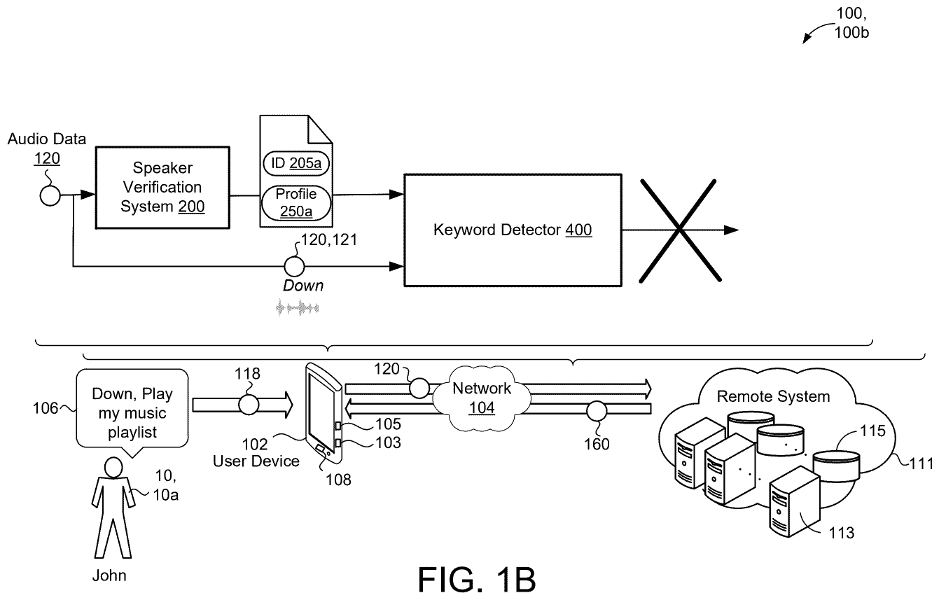

Referring to FIGS. 1A and 1, in some implementations, a system 100 includes a user device 102 associated with one or more users 10 and is in communication with a remote system 111 via a network 104. The user device 102 may correspond to a computing device, such as a mobile phone, computer (laptop or desktop), tablet, smart speaker/display, smart appliance, smart headphones, wearable device, vehicle infotainment system, etc., and is equipped with data processing hardware 103 and memory hardware 105. The remote system 111 may be a single computer, multiple computers, or a distributed system (e.g., cloud computing environment) having scalable/elastic computing resources (e.g., data processing hardware) 113 and/or storage resources (e.g., memory hardware) 115.

The user device 102 includes a keyword detector 400 (also referred to as a keyword detection model and/or hotword detector) configured to detect the presence of a keyword or hotword in streaming audio without performing semantic analysis or speech recognition processing on the streaming audio 118. That is, the keyword detector 40 may detect the presence of the keyword without transcribing any of the speech in the streaming audio (i.e., spoken audio) 118. In some examples, the keyword detector 400 is configured to detect the presence of any one of multiple keywords (e.g., hotwords). The keyword detector 400 may also be configured to detect the presence of user-defined keywords specific to a particular user 10. The user device 102 may include an acoustic feature extractor (not shown) which extracts audio data 120 from the utterances 106 spoken by the users 10. The audio data 120 may include acoustic features such as Mel-frequency cepstrum coefficients (MFCCs) or filter bank energies computed over windows of an audio signal. In the examples shown, a first user 10, 10a (e.g., John) speaks the utterance 106 of “Up, play my music playlist?” and “Down, play my music playlist”

The keyword detector 400 may receive the audio data 120 to determine whether the spoken utterance includes a particular keyword (e.g., “Ok Google” or “Up”). That is, the keyword detector 300 may be trained to detect the presence of the particular keyword (e.g., Up), one or more variations of the keyword (e.g., Hey Up), or multiple different keywords in the audio data 120. In response to detecting the particular keyword, the keyword detector 400 generates a keyword indication 405 causing the user device 102 to wake-up from a sleep state (e.g., low-power state) and trigger an automated speech recognition (ASR) system 180 to perform speech recognition on the keyword and/or one or more other terms that follow the keyword (e.g., a voice query/command that follow the keyword and specifies a particular action to perform). On the other hand, when the keyword detector 400 does not detect the presence of the keyword, the user device 102 remains in the sleep state such that the ASR system 180 does not process the audio data 120. Advantageously, keywords are useful for “always on” systems that may potentially pick up sounds or utterances that are not directed toward the user device 102. For example, the user of keywords may help the user device 102 discern when a given utterance 106 is directed at the user device 102, as opposed to a different given utterance 106 that is not directed at the user device 102 or a background noise. As such, the user device 102 may avoid triggering computationally expensive processing (e.g., speech recognition and semantic interpretation) on sounds or utterances 160 that do not include the keyword.

In some implementations, the keyword detector 400 employs a speaker-agnostic keyword detection model. That is, the speaker-agnostic keyword detection model uses the same model without any regard to an identity of the user. Stated differently, the speaker-agnostic keyword detection model processes audio data 120 to detect whether the keyword is present in the same manner for all users. Here, the speaker-agnostic keyword detection model may be trained on training data spoken by multiple different speakers in multiple different languages, accents, and/or dialects to learn to detect the presence of the keyword in audio for a plurality of users 10. That is, the speaker-agnostic keyword detection model may include a general model that is not trained to detect the keyword for any particular user, but is trained to detect the keyword when any user 10 from the one or more users 10 speak. Yet, in these examples, despite training the speaker-agnostic keyword detection model on thousands or even millions of hours of training data, the speaker-agnostic keyword detection model may be unable to accurately detect the presence of the keyword in audio for certain users 10. Namely, users 10 with rare or unseen voice characteristics included in the training data, such as, speech impediments (e.g., stuttering), unseen dialects (e.g., Rangpuri dialect), and children's speech. Simply put, because these rare or unseen voice characteristics were not included in the training data, the speaker-agnostic keyword detection model is unable to accurately detect the presence of the keyword in audio for certain users 10. For example, a child user may speak “Hey Google, Tell me a story,” but if the speaker-agnostic keyword detection model fails to detect the presence of the keyword “Hey Google,” then the ASR system 180 will not process the query of “Tell me a story” thereby degrading the experience for the user 10.

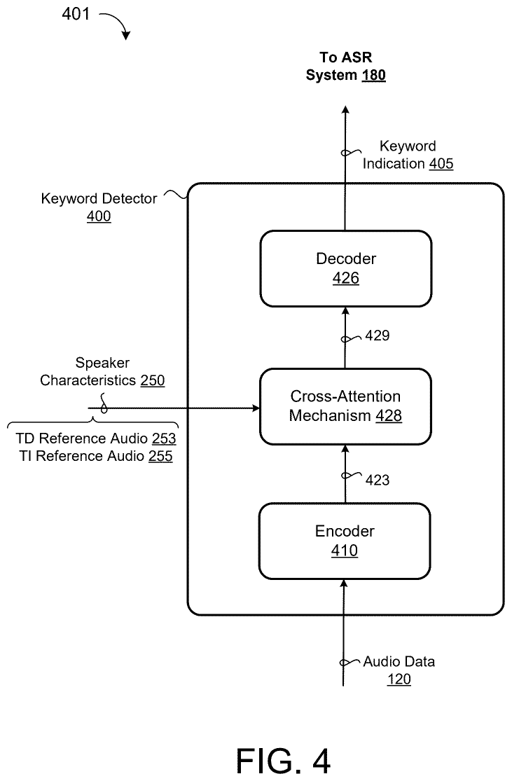

To that end, the keyword detector 400 may store a plurality of personal keyword detection models each personalized for a particular enrolled user 10 from multiple enrolled users 10. Discussed with greater detail with respect to FIG. 4, the personal keyword detection models are conditioned on speaker characteristic information associated with the particular users 10 to adapt the keyword detector 400 to detect the presence of the keyword in audio for the particular enrolled user 10. Stated differently, a personal keyword detection model for a particular user 10 may detect the keyword spoken by the particular user 10 (e.g., user with rare or unseen speaker characteristics) that the speaker-agnostic keyword detection model is unable to detect. As such, before detecting whether audio includes the keyword, the system 100 employs a speaker verification system 200 that is configured to determine an identity 205 of the user 10 that is speaking the utterance 106. Thus, by determining the identity 205 of the user 10 that is speaking the utterance 106 before detecting whether the keyword is present, the system 100 can obtain speaker characteristic information 250 associated with the enrolled user 10 to process the utterance 106 with the personal keyword detection model 420 (rather than the speaker-agnostic keyword detection model).

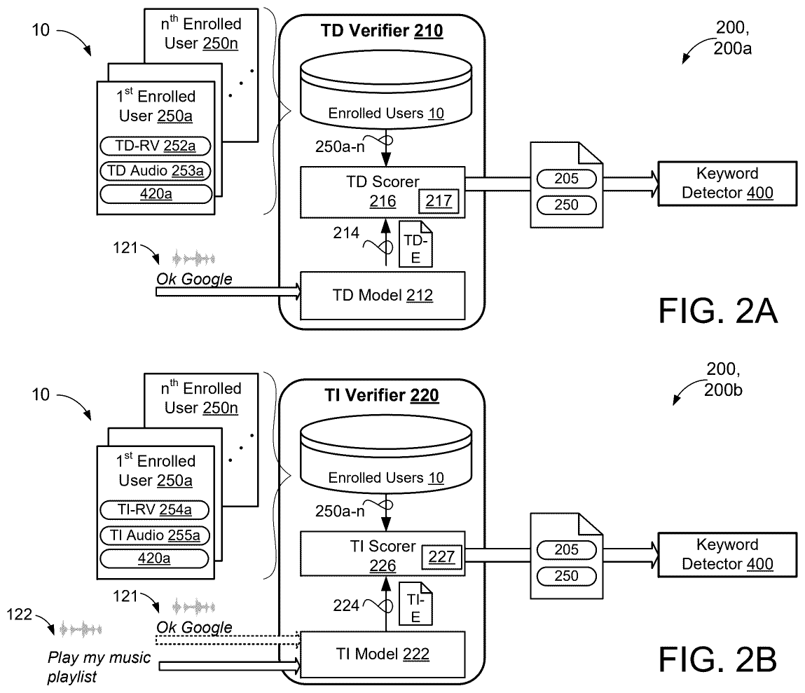

Referring now to FIGS. 2A and 2B, in some implementations, users 10 associated with the user device 102 may undertake a voice enrollment process in a speech verification system 200 to generate speaker characteristic information (e.g., user profile) 250 associated with each respective enrolled user 10. During the voice enrollment process, the user 10 may speak a user-defined custom keyword one or more times and/or provide the user-defined custom keyword by way of a textual input. Thereafter, the user-defined custom keyword may be stored as part of the user profile 250 associated with the user 10 such that the keyword detector 400 obtains the user-defined custom keyword during inference (FIGS. 1A and 1). The speaker verification system 200 may obtain respective enrollment reference vectors (e.g., speaker embeddings) 252, 254 and/or respective enrollment reference audio data 253, 255 from audio samples of one or more enrollment phrases spoken by the user 10 during the enrollment process. In some examples, the one or more enrollment phrases spoken by the user 10 during enrollment may be a predetermined term/phrase (e.g., the keyword the keyword detector 400 is configured to detect) such that the enrollment process generates a text-dependent reference vector (e.g., text-dependent speaker embedding) 252 or text-dependent reference audio data 253. In other examples, the one or more enrollment phrases spoken by the user 10 during enrolment includes free-form terms/phrases that are not predetermined such that the enrollment process generates a text-independent reference vector (e.g., text-independent speaker embedding) 254 or text-independent reference audio data 255. Discussed in greater detail with reference to FIG. 4, the enrollment reference vectors 252, 254 and/or the enrollment reference data 253, 255 may be used to condition the keyword detector 400 to detect the presence of the keyword.

Referring now specifically to FIG. 2A, in some examples, a first example speech verification system 200, 200a includes a text-dependent (TD) verifier 210 that has a TD speaker verification model 212 and a TD scorer 216. Moreover, the TD verifier 210 may store the speaker characteristic information (e.g., user profiles) 250, 250a-n in connection with the identities 205 of enrolled users 10. The TD speaker verification model 212 may generate one or more TD reference vectors (e.g., TD-RV) 252 from a predetermined term spoken in enrollment phrases by each enrolled user 10 that may be combined (e.g., averaged or otherwise accumulated) to form the respective TD reference vector 252. Here, the predetermined term spoken by each enrolled user 10 may be the predetermined keyword or another predetermined term. The TD verifier 210 stores the TD reference vector 252 in connection with the respective user profile 250 associated with the user 10 that spoke the enrollment utterance. In some examples, in addition to, or in lieu of, storing the TD reference vector 252 the TD verifier 210 stores the TD reference audio data 253 in connection with the respective user profile 250 associated with the user 10 that spoke the enrollment utterance. That is, instead of generating a reference vector 252 from the enrollment utterances, the TD verifier 210 stores the TD reference audio data 253 directly.

In some examples, after a user has performed the enrollment process, the TD verifier 210 performs speaker identification on the audio data 120 to identify the identity 205 of the particular user that spoke the utterance. The TD verifier 210 identifies the user 10 that spoke the utterance 106 by first extracting, from the first portion 121 of the audio data 120 that characterizes the predetermined keyword spoken by the user, a TD evaluation vector (e.g., TD-E) 214 representing voice characteristics of the utterance of the keyword. Here, the TD verifier 210 may execute the TD speaker verification model 212 configured to receive the first portion 121 (e.g., characterizing the portion of the utterance corresponding to the keyword) of the audio data as input and generate, as output, the TD evaluation vector 214. The TD speaker verification model 212 may be a neural network model trained using machine or human supervision to output the TD evaluation vector 214.

Once the TD evaluation vector 214 is output from the TD speaker verification model 212, the TD verifier 210 determines whether the TD evaluation vector 214 matches any of the stored user profiles 250 (e.g., stored at the memory hardware 105 and/or the memory hardware 115) in connection with identities 205 of the enrolled users 10. In particular, the TD verifier 210 may compare the TD evaluation vector 214 to the TD reference vector 252 or the TD reference audio data 253. Here, each TD reference vector 252 may be used as a reference vector corresponding to a voiceprint or unique identifier representing characteristics of the voice of the respective enrolled user 10 speaking the predetermined keyword.

In some implementations, the TD verifier 210 uses a TD scorer 216 that compares the TD evaluation vector 214 to the respective TD reference vector 252 associated with each enrolled user 10 of the user device 102. Here, the TD scorer 216 may generate a score for each comparison indicating a likelihood that the utterance 106 corresponds to an identity 205 of the respective enrolled user 10. Specifically, the TD scorer 216 generates a TD confidence score 217 for each enrolled user 10 of the user device 102. In some implementations, the TD scorer 216 determines the TD confidence score by determining a respective cosine distance between the TD evaluation vector 214 and each TD reference vector 252 to generate the TD confidence score 217 for each respective enrolled user 10.

Thereafter, the TD scorer 216 determines whether any of the TD confidence scores 217 satisfy a confidence threshold. When the TD confidence score 217 satisfies the confidence threshold, the TD scorer 216 outputs the identity 205 of the particular user that spoke the utterance and the associated user profile 250 to the keyword detector 400. On the other hand, when the TD confidence score fails to satisfy the confidence threshold, the TD scorer 216 does not output any identity or user profile 250 to the keyword detector 400.

Referring now to FIG. 2B, in some examples, a second example speech verification system 200, 200b includes a text-independent (TI) verifier 220 that has a TI speaker verification model 222 and a TI scorer 226. Moreover, the TI verifier 220 may store the user profiles 250, 250a-n in connection with the identities 205 of enrolled users. The TI speaker verification model 222 may generate one or more TI reference vectors (e.g., TI-RV) 254 from audio samples of enrollment phrases spoken by each enrolled user that may be combined (e.g., averaged or otherwise accumulated) to form the respective TI reference vector 254. Here, the enrollment phrases spoken may be free-form users including any speech the user wishes to speak. Thus, the enrollment phrases may be different than the keyword or any phrase the user wishes to speak. The TI verifier 220 stores the TI reference vector 254 in connection with the respective user profile 250 associated with the user 10 that spoke the enrollment utterance. In some examples, in addition to, or in lieu of, storing the TI reference vector 254 the TI verifier 220 stores the TI reference audio data 255 in connection with the respective user profile 250 associated with the user 10 that spoke the enrollment utterance. That is, instead of generating a TI reference vector 254 from the enrollment utterances, the TI verifier 220 stores the TI reference audio data 255 directly. Moreover, the TI verifier 220 may store the personalized keyword detection model 420 in connection with the respective user profile 250 associated with the user 10 that spoke the enrollment utterance.

In some examples, after a user has performed the enrollment process, the TI verifier 220 performs speaker identification on the audio data 120 to identify the identity 205 of the particular user that spoke the utterance. The TI verifier 220 identifies the user 10 that spoke the utterance 106 by first extracting, from the second portion 122 of the audio data 120 that characterizes the query including free-form speech or the query following the predetermined keyword spoken by the user, a TD evaluation vector (e.g., TD-E) 214 representing voice characteristics of the utterance. Here, the TI verifier 220 may execute the TD speaker verification model 212 configured to receive the first portion 121 of the audio data as input and generate, as output, the TD evaluation vector 214. The TI speaker verification model 222 may be a neural network model trained using machine or human supervision to output the TI evaluation vector 224.

Once the TI evaluation vector 224 is output from the TI speaker verification model 222, the TI verifier 220 determines whether the TI evaluation vector 224 matches any of the stored user profiles 250 (e.g., stored at the memory hardware 105 and/or the memory hardware 115) in connection with identities 205 of the enrolled users 10. In particular, the TI verifier 220 may compare the TI evaluation vector 224 to the TI reference vector 254 or the TI reference audio data 255. Here, each TI reference vector 254 may be used as a reference vector corresponding to a voiceprint or unique identifier representing characteristics of the voice of the respective enrolled user 10.

In some implementations, the TI verifier 220 uses a TI scorer 226 that compares the TI evaluation vector 224 to the respective TI reference vector 254 associated with each enrolled user 10 of the user device 102. Here, the TI scorer 226 may generate a score for each comparison indicating a likelihood that the utterance 106 corresponds to the identity 205 of the respective enrolled user 10. Specifically, the TI scorer 226 generates a TI confidence score 227 for each enrolled user 10 of the user device 102. In some implementations, the TI scorer 226 determines the TI confidence score 227 by determining a respective cosine distance between the TI evaluation vector 224 and each TI reference vector 254 to generate the TI confidence score 227 for each respective enrolled user 10.

Thereafter, the TI scorer 226 determines whether any of the TI confidence scores 227 satisfy a confidence threshold. When the TI confidence score 227 satisfies the confidence threshold, the TI scorer 226 outputs the identity 205 of the particular user that spoke the utterance and the associated user profile 250 to the keyword detector 400. On the other hand, when the TI confidence score 227 fails to satisfy the confidence threshold, the TI scorer 226 does not output any identity or user profile 250 to the keyword detector 400.

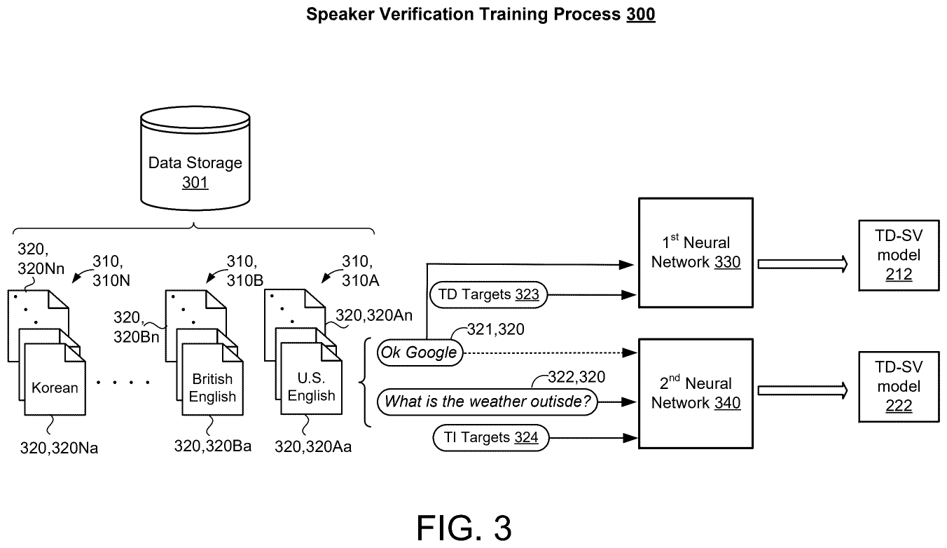

FIG. 3 shows an example speaker verification training process 300 for training the speaker verification system 200. The example speaker verification training process 300 (also referred to as simply “training process 300”) obtains a plurality of training datasets 310, 310A-N stored in data storage 301 and trains each of the TD speaker verification model 212 and the TI speaker verification model 222 on the training datasets 310. Each training dataset 310 may be associated with a different respective language or dialect and includes corresponding training utterances 320, 320Aa-Nn spoken in the respective language or dialect by different speakers. For instance, a first training dataset 310A may be associated with American English speakers that include corresponding training utterances 320Aa-An each spoken in English by speakers from the United States of America. That is, the training utterances 320Aa-An in the first training dataset 310A are all spoken in English with an American accent. On the other hand, a second training dataset 310B may be associated with British English speakers that includes corresponding training utterances 320Ba-Bn also spoken in English, but by speakers from Great Britain. Accordingly, the training utterances 320Ba-Bn in the second training data set 310B are spoken in English with a British accent, and are therefore associated with a different dialect (i.e., British Accent) than the training utterances 320Aa-An associated with the American accent dialect. Notably, an English speaker with a British accent may pronounce some words differently than another English speaker with an American accent. FIG. 3 also shows another training data set 310N associated with Korean that includes corresponding training utterances 320Na-Nn spoken by Korean speakers.

Each corresponding training utterance includes a text-dependent (TD) portion 321 and a text-independent (TI) portion 322. The TD portion 321 includes an audio segment characterizing a predetermined keyword (e.g., “Hey Google”) or a variant of the predetermined keyword (e.g., “Ok Google”) spoken in the training utterance 320. Here, the predetermined keyword and variant thereof may each be detectable by the keyword detector 400 when spoken in streaming audio 118 to trigger the user device to wake-up and initiate speech recognition on one or more terms following the predetermined hotword or variant thereof. In some examples, the fixed-length audio segment associated with the TD portion 321 of the corresponding training utterance 320 that characterizes the predetermined keyword is extracted by the keyword detector 400.

The TI portion 322 in each training utterance 320 includes an audio segment that characterizes a query statement spoken in the training utterance 320 following the predetermined hotword characterized by the TD portion 321. For instance, the corresponding training utterance 320 may include “Ok Google, What is the weather outside?” whereby the TD portion 321 characterizes the hotword “Ok Google” and the TI portion 322 characterizes the query statement “What is the weather outside?” While the TD portion 321 in each training utterance 320 is phonetically constrained by the same predetermined keyword or variation thereof, the lexicon of the query statement characterized by each TI portion 322 is not constrained such that the duration and phonemes associated with each query statement is variable. Notably, the language of the spoken query statement characterized by the TD portion 321 includes the respective language associated with the training dataset 310. For instance, the query statement “What is the weather outside” spoken in English translates to “Cual es el clima afuera” when spoken in Spanish. In some examples, the audio segment characterizing the query statement of each training utterance 320 includes a variable duration ranging from 0.24 seconds to 1.60 seconds.

With continued reference to FIG. 3, the training process 300 trains a first neural network 330 on the TD portions 321 of the training utterances 320, 320Aa-Nn spoken in the respective language or dialect associated with each training dataset 310, 310A-N. During training, additional information about the TD portions 321 may be provided as input to the first neural network 330. For instance, text-dependent (TD) targets 323 corresponding to ground-truth output labels for training the TD speaker verification model 212 to learn how to predict may be provided as input to the first neural network 330 during training with the TD portions 321. The TD targets 323 may be ground-truth labels for TD evaluation vectors 214 (e.g., when training on TD reference vectors 252) or ground-truth labels for TD audio (e.g., when training on TD reference audio data 253). Thus, one or more utterances of the predetermined keyword from each particular speaker may be paired with a particular TD target 323.

The first neural network 330 may include a deep neural network formed from multiple long short-term memory (LSTM) layers with a projection layer after each LSTM layer. In some examples, the first neural network uses 128 memory cells and the projection size is equal to 64. The TD speaker verification model 212 includes a trained version of the first neural network 330. The TD evaluation and reference vectors 214, 252 generated by the TD speaker verification model 212 may include d-vectors or i-vectors with an embedding size equal to the projection size of the last projection layer. The training process may use generalized end-to-end contrast loss for training the first neural network 330.

After training, the first neural network 330 generates the TD speaker verification model 212. The TD speaker verification model 212 may be pushed to a plurality of user device 102 distributed across multiple geographical regions and associated with users that speak different languages, dialects, or both. The user devices 102 may store and execute the TD speaker verification model 212 to perform text-dependent speaker verification on audio segments characterizing the predetermined keyword spoken by any of the enrolled users of the user device 102.

The training process 300 also trains a second neural network 340 on the TI portions 322 of the training utterances 320, 320Aa-Nn spoken in the respective language or dialect associated with each training dataset 310, 310A-N. Here, for the training utterance 320Aa, the training process 300 trains the second neural network 340 on the TI portion 322 characterizing the query statement “what is the weather outside” spoken in American English. Optionally, the training process 300 may also trains the second neural network 340 on the TD portion 321 (not shown) of at least one corresponding training utterance 320 in one or more of the training datasets 310 in addition to the TI portion 322 of the corresponding training utterance 320. For instance, using the training utterance 320Aa above, the training process 300 may train the second neural network 340 on the entire utterance “Ok Google, what is the weather outside” During training, additional information about the TI portions 322 may be provided as input to the second neural network 340. For instance, TI targets 324 corresponding to ground-truth output labels for training the TI speaker verification model 222 to learn how to predict may be provided as input to the second neural network 340 during training with the TI portions 322. The TI targets 324 may be ground-truth labels for TI evaluation vectors 224 (e.g., when training on TI reference vectors 254) or ground-truth labels for TI audio (e.g., when training on TI reference audio data 255). Thus, one or more utterances of query statements from each particular speaker may be paired with a particular TI target 324.

The second neural network 340 may include a deep neural network formed from LSTM layers with a projection layer after each LSTM layer. In some examples, the second neural network uses 384 memory cells and the projection size is equal to 128. The TI speaker verification model 222 includes a trained version of the second neural network 340. The TI evaluation and reference vectors 252, 254 generated by the TI speaker verification model 222 may include d-vectors or i-vectors with an embedding size equal to the projection size of the last projection layer. The training process 300 may use generalized end-to-end contrastive losses for training the first and second neural networks 330, 340.

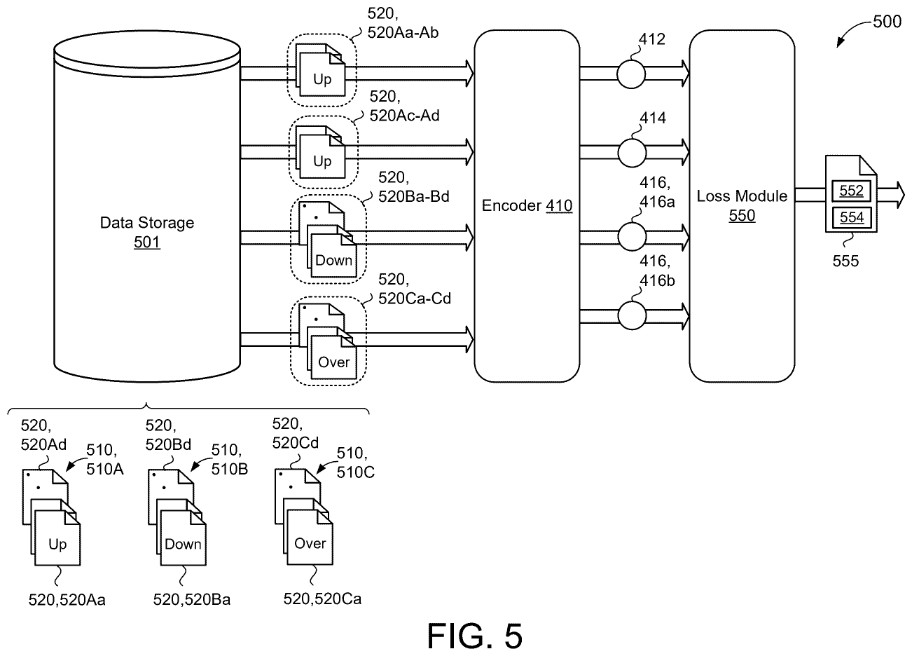

FIG. 5 shows an example training process 500 for training the keyword detector 400. The training process 500 receives a plurality of sets of utterances 510 from data storage. Each respective set of utterances 510 includes audio data samples 520 of a corresponding utterance that is different than the corresponding utterance of each other set of utterances 510 of the plurality of sets of utterances. As such, the audio data samples 520 of each set of utterance 510 may characterize a particular keyword different than the particular keyword of each other set of utterances 510. In the example shown, the training process 500 receives a first set of utterances 510, 510A that includes four audio data samples 520Aa-Ad for the keyword “up,” a second set of utterances 510, 510B that includes four audio data samples 520Ba-Bd for the keyword “down,” and a third set of utterances 510, 510C that includes four audio data samples 520Ca-Cd for the keyword “over.” However, it is understood that the plurality of sets of utterances 510 may include any number of sets of utterances 510 and each set of utterances 510 may include any number of audio data samples 520 irrespective of the number of audio data samples 520 of other sets of utterances 510.

The corresponding utterance may include a user-defined custom keyword. For instance, the user 10 may provide the user-defined custom keyword during the enrollment process (FIGS. 2A and 2B) by speaking the custom keyword one or more times or providing the custom keyword via textual input. Thus, the audio data samples 520 may include at least one of non-synthetic audio data samples (e.g., spoken by a user) or synthetic audio data samples (e.g., generated by a text-to-speech model using a textual input). Moreover, each audio data samples 520 of a respective set of utterances 510 includes speech characteristics (e.g., pitch, prosody, accent, style, etc.) speaking the corresponding utterance different than at least one other audio data sample 520 of the respective set of utterances 510. For example, the first set of utterances 510 may include four audio data samples 520Aa-Ad of the term “up” each spoken by a different speaker with different speaker characteristics.

During each of a plurality of training iterations, the training process 500 may select one of the plurality of sets of utterances 510 to represent the user-defined keyword. For each iteration, the training process 500 trains the keyword detector 400 using the selected one of the plurality of sets of utterances 510 to represent the user-defined keyword. After each iteration, the training process 500 selects another one of the plurality of sets of utterances 510 to represent the user-defined keyword and trains the keyword detector 400 using the selected other one of the plurality of sets of utterances 510 to represent the user-defined keyword. In the example shown, the training process 500 selects the first set of utterances 510A to represent the user-defined keyword by way of example only.

For the selected one of the plurality of utterances (e.g., a respective one of the set of utterances) 510, the training process assigns one or more audio data samples 520 from the selected one of the plurality of utterances 510 to an enrollment subset and assigns each other audio data sample 520 from the selected one of the plurality of utterances 510 not assigned to the enrollment subset to a test subset. Here, the enrollment subset of audio data samples 520 represent audio data samples 520 spoken by the user 10 during the enrollment process to provide the user-defined keyword. On the other hand, the test subset of audio data samples 520 represent audio data samples 520 spoken by the user 10 during inference after the user 10 has completed the enrollment process to provide the user-defined keyword. Thus, by creating the enrollment subset and the test subset the training process 500 emulates the two-stage nature of the enrollment process of the user-defined keyword and subsequently receiving the user-defined keyword during training.

In the example shown, the training process 500 assigns a first and second audio data sample 520Aa, 520Ab from the first set of utterances 510 to the enrollment subset and a third and fourth audio data sample 520Ac, 520Ad to the test subset. Assigning the audio data samples 520 to the enrollment subset and the test subset may include randomly sampling the audio data samples. In some implementations, the training process 500 assigns the same number of audio data samples 520 to the enrollment subset and the test subset. In other implementations, the training process 500 assigns a different number of audio data samples 520 to the enrollment subset of the test subset.

For the selected one of the plurality of utterances (e.g., a respective one of the set of utterances) 510, the training process 500 determines, using the encoder 410, a keyword enrollment embedding 412 for the enrollment subset of the audio samples 520 of the selected one of the plurality of utterances 510 and determines, using the encoder 410, a corresponding matching keyword test embedding 414 for each respective audio data sample 520 of the test subset of the audio data samples 520. That is, the encoder 410 may determine a corresponding keyword enrollment embedding 412 for each respective audio data sample 520 of the enrollment subset and determine a centroid keyword enrollment embedding based on the corresponding keyword enrollment embedding 412 determined for each respective audio data sample 520 of the enrollment subset. Here, the centroid keyword enrollment embedding may serve as the keyword enrollment embedding 412 for the enrollment subset. The encoder 410 may determine the centroid keyword enrollment embedding according to:

$${c}_{i} = \frac{1}{Y / 2} {\sum }^{Y} {j = 1}_{j ( mod 2 ) \neq 0} {e}_{i j} \qquad ( 1 )$$

In Equation 1, cᵢ represents the centroid keyword enrollment embedding and Y represents the number of phrases in the selected on of the sets of utterances 510.

In the example shown, the encoder 410 determines a corresponding keyword enrollment embedding 412 for the first audio data sample 520Aa and the second audio data sample 520Ab and determines the centroid keyword enrollment embedding based on the corresponding keyword enrollment embeddings determined for the first audio data sample 520Aa and the second audio data sample 520Ab. Thus, the centroid keyword enrollment embedding 412 serves as a single embedding that represents all the audio data samples 520 from the enrollment subset. Continuing with the example shown, the encoder 410 determines a corresponding matching keyword test embedding 414 based on the third audio data sample 520Ac and determines a corresponding matching keyword test embedding 414 based on the fourth audio data sample 520Ad. As such, the encoder 410 determines a corresponding matching keyword test embedding 414 for each audio data sample 520 in the test subset which may be in contrast to determining the single keyword enrollment embedding 412 for all the audio data samples 520 in the enrollment subset. As will become apparent, the matching keyword test embeddings 414 represent embeddings determined by the encoder 410 for speech that includes the user-defined keyword. Put another way, the encoder 410 determines the keyword enrollment embedding 412 and the matching keyword test embedding 414 based on audio data samples 520 that include the user-defined keyword.

For each respective audio data sample 520 of each other set of utterances 510 (e.g., the set of utterances 510 other than the respective one of the set of utterances 510), the training process 500 determines, using the encoder 410, a corresponding nonmatching keyword test embedding 416. In the example shown, the other set of utterances 510 include the second set of utterances 510B and the third set of utterances 510C. Thus, the encoder 410 determines a first corresponding nonmatching keyword test embedding 416, 416a for each respective audio data sample 520Ba-Bd of the second set of utterances 510B (e.g., four total first corresponding nonmatching keyword test embeddings 416a) and determines a second corresponding nonmatching keyword test embedding 416, 416b for each respective audio data sample 520Ca-Cd of the third set of utterances 510C (e.g., four total second corresponding nonmatching keyword test embeddings 416b).

The loss module 550 receives the keyword enrollment embedding 412, the matching keyword test embeddings 414, and the nonmatching keyword test embeddings 416 and determines an overall loss 555. The overall loss 555 may include a first loss 552 and a second loss 554. As such, the training process 500 may train the keyword detector 400 based on the overall loss 555 or specifically on the first loss 552 or the second loss 554. In some examples, training the keyword detector 400 includes updating parameters of the keyword detector 400 based on the loss. For instance, the training process 500 may update parameters of the encoder 410 of the keyword detector 400 based on the loss.

In some examples, the loss module 550 determines the first loss 552 based on the keyword enrollment embedding 412 and the matching keyword test embeddings 414. In particular, the loss module 550 may compare each matching keyword test embedding 414 to the keyword enrollment embedding 412 to determine the first loss 552. For instance, the loss module 550 may determine a cosine similarity between the keyword enrollment embedding 412 and each matching keyword test embedding 414. Thereafter, the loss module 550 determines the first loss 552 based on each cosine similarity determined between the keyword enrollment embedding 412 and the matching keyword test embeddings 414. The loss module 550 may determine the first loss 552 according to:

$${p}_{i} = \{ {e}_{i j} \vert j ( mod 2 ) \neq 1 \} \qquad ( 2 )$$

Since the encoder 410 determined the keyword enrollment embedding 412 and the matching keyword test embeddings 414 based on audio data samples 520 which correspond to the same utterance (e.g., user-defined keyword), the keyword enrollment embedding 412 and the matching keyword test embeddings 414 should be similar to one another. Thus, the training process 500 may aim to minimize the first loss 552 to teach the encoder 410 to determine similar embeddings for audio corresponding to the user-defined keyword regardless of whether the audio was spoken during the enrollment process or during inference. For example, the encoder 410 determined the keyword enrollment embedding 412 based on the audio data samples 520Aa, 520Ab each corresponding to the utterance “up” and determined the matching keyword test embedding 414 based on the audio data samples 520Ac, 520Ad each corresponding to the utterance “up.” As such, in this example, the training process 500 aims to minimize the first loss 552 between these embeddings 412, 414 each corresponding to the utterance up.

In some implementations, the loss module 550 determines the second loss 554 based on the keyword enrollment embedding 412 and the nonmatching keyword test embeddings 416. In particular, the loss module 550 may compare each nonmatching keyword test embedding 416 to the keyword enrollment embedding 412 to determine the second loss 554. For instance, the loss module 550 may determine a cosine similarity between the keyword enrollment embedding 412 and each nonmatching keyword test embedding 416. Thereafter, the loss module 550 determines the second loss 554 based on each cosine similarity determined between the keyword enrollment embedding 412 and the nonmatching keyword test embeddings 416. The loss module 550 may determine the second loss 554 according to:

$${n}_{i} = \{ {e}_{k j} \vert j ( mod 2 ) \neq 1 , k = 1 , 2 , … , X and k \neq i \} \qquad ( 3 )$$

Since the encoder 410 determined the keyword enrollment embedding 412 and the nonmatching keyword test embeddings 416 based on audio data samples 520 which correspond to different utterances, the keyword enrollment embedding 412 and the nonmatching keyword test embeddings 416 should not be similar to one another. Thus, the training process 500 may aim to maximize the second loss 554 to teach the encoder 410 to determine different embeddings for audio corresponding to the user-defined keyword and any other utterance regardless of whether the audio was spoken during the enrollment process or during inference. For example, the encoder 410 determined the keyword enrollment embedding 412 based on the audio data samples 520Aa, 520Ab each corresponding to the utterance “up,” determined the first nonmatching keyword test embeddings 416a based on the audio data samples 520Ba-Bd each corresponding to the utterance “down,” and determined the second nonmatching keyword test embeddings 416b based on the audio data samples 520Ca-Cd each corresponding to the utterance “over.” As such, in this example, the training process 500 aims to maximize the second loss 554 between the keyword enrollment embeddings 412 and the nonmatching keyword test embeddings 416. The loss module 350 may determine the overall loss 355 based on the first loss 352 and the second loss 354 according to:

$$L ( {c}_{i} ) = log {\sum }_{n ∈ {n}_{i}} exp cos ( {c}_{i} , n ) - log {\sum }_{p ∈ {p}_{i}} exp cos ( {c}_{i} , p ) \qquad ( 4 )$$

Accordingly, FIG. 5 shows an example iteration of the training process 500 whereby the first set of utterances 510A are selected to represent the enrollment utterances for the user-defined keyword. Thereafter, in a subsequent iteration, the training process 500 may select another set of utterances 510 to represent the enrollment utterances for the user-defined keyword. For example, in the subsequent iteration, the training process 500 may select the second set of utterances 510B and assign the second set of utterances to the enrollment subset and the test subset such that the first and third set of utterances 510A, 510C are now the other set of utterances 510.

Referring now specifically to FIG. 1A, in some examples, for a first example system 100, 100a the first user 10a (e.g., John) speaks the utterance 106 of “Up, Play my music playlist.” Notably, the first user 10a is an enrolled user that the speaker verification system 200 generated first speaker characteristics information (e.g., user profile) 250. Thus, the speaker verification system 200 identifies a first identity 205a and a first user profile 250a associated with the first user 10a by processing the utterance 106. The keyword detector 400 receives the first identity 205a and the first user profile 150a associated with the first user 10a. The user profile 250 may indicate to the keyword detector 400 one or more user-defined custom keywords provided by the user 10 (e.g., via textual input or speech input) during the enrollment process. The one or more user-defined custom keywords may be used by the keyword detector 400 to generate the keyword indication 405 in addition to, or in lieu of, any generic keywords.

Described in greater detail with reference to FIG. 4, the keyword detector 400 may be conditioned on speaker characteristic information 250 (e.g., reference vectors 252, 254, and/or reference audio data 253, 255 (FIGS. 2A and 2B)) associated with the first user 1Oa to adapt the keyword detector 400 to detect the presence of the keyword in audio for the first user 10a. In the example shown, the first user 10a provided the user-defined custom keyword of “up.” To that end, the keyword detector 400 generates the keyword indication 405 when the first user 10a speaks the keyword of “up” to indicate to the ASR system 180 to process speech that follows the keyword. Thus, in this example, based on the keyword detector 400 detecting the presence of the custom keyword from the audio data 120, the keyword detector 400 outputs the keyword indication 405 to the ASR system 180.

In response to receiving the keyword indication 405, the ASR system 180 processes the second portion 122 of the utterance 106 of “Play my playlist” spoken by the first user 10a. In particular, the ASR system 180 includes an ASR model 182 configured to perform speech recognition on the second portion 122 of the audio data 120 that characterizes the query. The ASR system 180 also includes a natural language understanding module (NLU) 184 configured to perform query interpretation on the speech recognition result output by the ASR model 182. Generally, the NLU module 184 may perform semantic analysis on the speech recognition result to identify the action to perform that is specified by the query. In some examples, the NLU module 184 includes a large language model (LLM) capable of not only performing query interpretation on the speech recognition result output by the ASR model 182, but also performing text generation tasks based on the speech recognition result. Additionally or alternatively, the ASR model 182 may include an audio encoder and a text decoder that includes a LLM such that the LLM is capable of not only decoding audio encodings into text associated with speech recognition results, but also performing semantic analysis on the speech recognition results and/or downstream text generation tasks based on the speech recognition results. In some examples, the ASR system 180 receives the first identity 205a and the first user profile 250a associated with the first user 10a, and personalizes the speech recognition for the first user 10a. For instance, the ASR system 180 may determine the “music playlist” from the utterance 106 is referencing a music playlist associated with the first user 10a. Thereafter, the user device 102 may send the response including an audio track from John's music playlist for the user device 102 to play for audible output from a speaker.

Referring now specifically to FIG. 1B, in some examples, for a second example system 100, 100b the first user 10a (e.g., John) speaks the utterance 106 of “Down, Play my music playlist.” Notably, the first user 10a is an enrolled user that the speaker verification system 200 generated first speaker characteristics information (e.g., user profile) 250. Thus, the speaker verification system 200 identifies a first identity 205a and a first user profile 250a associated with the first user 10a by processing the utterance 106. The keyword detector 400 receives the first identity 205a and the first user profile 150a associated with the first user 10a. The user profile 250 may indicate to the keyword detector 400 one or more user-defined custom keywords provided by the user 10 (e.g., via textual input or speech input) during the enrollment process. The one or more user-defined custom keywords may be used by the keyword detector 400 to generate the keyword indication 405 in addition to, or in lieu of, any generic keywords.

Yet, in the example shown the term “down” is neither a custom keyword or a generic keyword. Thus, in this example, the keyword detector 400 does not detect the presence of the keyword and does not generate the keyword indication 405.

Consequently, the ASR system 180 does not process the second portion 122 of the audio data 120. That is, the ASR system 180 only processes the second portion 122 when the keyword indication 405 is received. Thus, the query spoken by the first user 10a is not processed by the ASR system 180.

FIG. 4 shows an example conditioning process 401 for conditioning the keyword detector 400 on speaker characteristic information 250. In some implementations, the conditioning process 401 occurs during the enrollment process described with reference to FIGS. 2A and 2B. That is, after generating the speaker characteristic information 250 for the user 10 that spoke the enrollment utterances, the conditioning process 401 may condition the keyword detector 400 such that the personal keyword detection model is pre-determined before the user 10 speaks any utterances 106 directed towards the user device 102. Advantageously, performing the conditioning process 401 in this manner limits computational resources (and therefore the observed latency) when the enrolled user 10 speaks the utterance 106 that is directed towards the user device 102 to perform some action. In other implementations, the conditioning process 401 occurs as the user speaks utterances 106 directed towards the user device 102. For instance, the conditioning process 401 would not occur until after the first user 10a spoke the utterance 106 of “Hey Google, play my music playlist” in an on-the-fly configuration by obtaining the speaker characteristic information 250 from memory hardware 105, 115 in communication with the data processing hardware 103, 113. The conditioning process 401 may occur at the remote system 111 and/or the user device 102.

The keyword detector 400 may include an encoder 410, a cross-attention mechanism 428, and a decoder 426. The encoder 410 may include a stack of multi-head self-attention layers. For example, the encoder 410 may include a conformer encoder having a stack of conformer layers or a transformer encoder having a stack of transformer layers. In some examples, the conditioning process 401 uses the speaker characteristic information 250 that includes the reference audio data 253, 355 and/or the reference vector 252, 254 (not shown) to condition the keyword detector 400. The encoder 422 is configured to receive, as input, the audio data 120 corresponding to the utterance spoken by the user 10 and generate, as output, the audio encoding 423. Here, the utterance received by the encoder 422 may correspond to the enrollment utterances or the utterances 106 spoken by the users 10 during inference (FIGS. 1A and 1). The cross-attention mechanism 428 receives the audio encoding 423 generated by the encoder 422 and the speaker characteristic information 250 (e.g., the TD reference audio data 253 and/or the TI reference audio data 255). The cross-attention mechanism 428 may include a stack of cross-attention layers such as conformer or transformer layers. Thus, the cross-attention mechanism 428 is configured to perform cross-attention between the audio encoding 423 and the TD reference audio data 253 and/or TI reference audio data 255 to generate, as output, a cross-attention output 429. Stated differently, the conditioning process 401 may initially obtain the speaker-agnostic keyword detection model and condition the cross-attention mechanism 428 by processing the TD reference audio data 253 and/or TI reference audio data 255 to generate the personal keyword detection model.

Notably, the cross-attention output 429 conditions the personal keyword detection model to detect the presence of the keyword spoken by the particular user 10. The decoder 426 receives the cross-attention output 429 as input and generates, as output, the keyword indication 405 when the audio data 120 includes the keyword. Here, the decoder 426 outputs the keyword indication 405 to the ASR system 180 thereby causing the ASR system 180 to perform speech recognition on the audio data. Otherwise, the decoder 426 does not output the keyword indication 405 such that the ASR system 180 does not process the audio data 120.

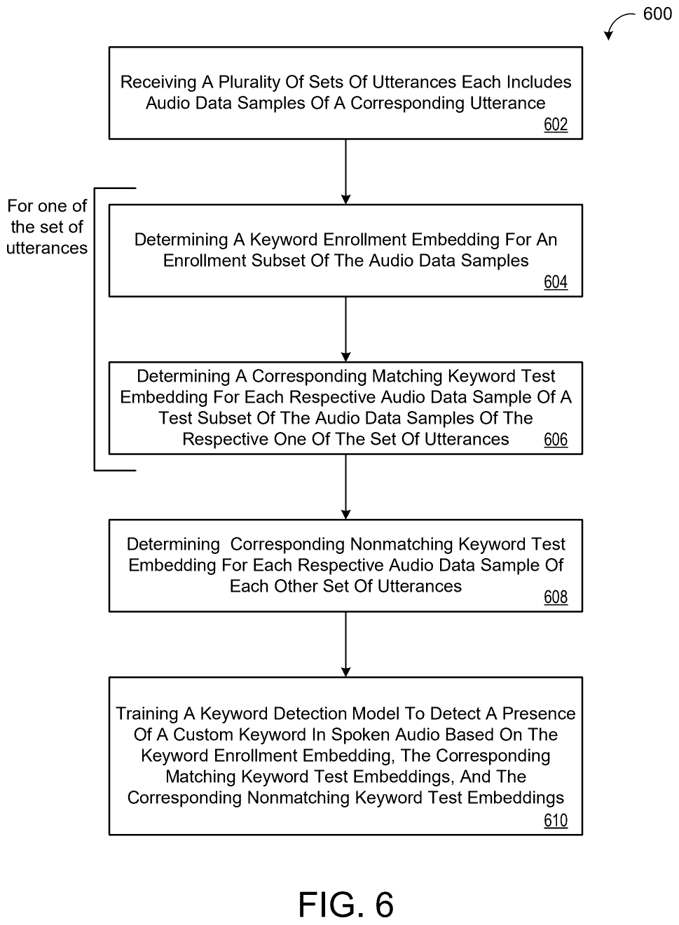

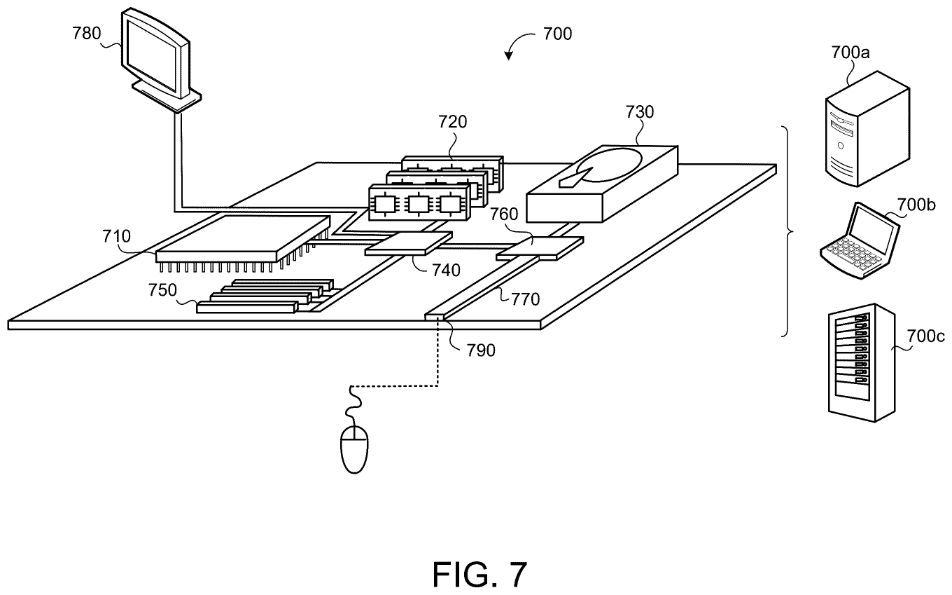

FIG. 6 illustrates a flowchart of an example flowchart of operations for a computer-implemented method 600 of training a keyword detection model to detect custom phrases. The method 600 may execute on data processing hardware 710 (FIG. 7) using instructions stored on memory hardware 720 (FIG. 7) that may reside on the user device 102 and/or the remote system 110 of FIG. 1 each corresponding to a computing device 700 (FIG. 7).

At operation 602, the method 600 includes receiving a plurality of sets of utterances 510. Each respective set of utterances 510 includes audio data samples 520 of a corresponding utterance different than the corresponding utterance of each other set of utterances 510 of the plurality of sets of utterances 510. For a respective one of the sets of utterances 510, the method 600 performs operations 604 and 606. At operation 604, the method 600 includes determining a keyword enrollment embedding 512 for an enrollment subset of the audio data samples 520 of the respective one of the sets of utterances 510. At operation 606, the method 600 includes determining a corresponding matching keyword test embedding 514 for each respective audio data sample of a test subset of the audio data samples 520 of the respective one of the sets of utterances 510. At operation 608, the method 600 includes determining a corresponding nonmatching keyword test embedding 516 for each respective audio data sample 520 of each of the other sets of utterances 510. At operation 610, the method 600 includes training a keyword detection model 400 to detect a presence of a custom keyword in spoken audio 118 based on the keyword enrollment embedding 512, the corresponding matching keyword test embedding 514 determined for each respective audio data sample 520 of the test subset, and the corresponding nonmatching keyword test embedding 516 determined for each respective audio data sample 520 of each of the other sets of utterances

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving a plurality of sets of utterances, each respective set of utterances comprising audio data samples of a corresponding utterance different than the corresponding utterance of each other set of utterances of the plurality of sets of utterances;
for a respective one of the sets of utterances:
determining a keyword enrollment embedding for an enrollment subset of the audio data samples of the respective one of the sets of utterances; and
for each respective audio data sample of a test subset of the audio data samples of the respective one of the sets of utterances, determining a corresponding matching keyword test embedding;
for each respective audio data sample of each of the other sets of utterances, determining a corresponding nonmatching keyword test embedding; and
training a keyword detection model to detect a presence of a custom keyword in spoken audio based on the keyword enrollment embedding, the corresponding matching keyword test embedding determined for each respective audio data sample of the test subset, and the corresponding nonmatching keyword test embedding determined for each respective audio data sample of each of the other sets of utterances.

2. The computer-implemented method of claim 1, wherein determining the keyword enrollment embedding for the enrollment subset of the audio data samples comprises:
for each respective audio data sample of the enrollment subset, determining a corresponding keyword enrollment embedding; and
determining a centroid keyword enrollment embedding based on the corresponding keyword enrollment embedding determined for each respective audio data sample of the enrollment subset.

3. The computer-implemented method of claim 1, wherein training the keyword detection model comprises minimizing a first loss between the keyword enrollment embedding and the corresponding matching keyword test embedding determined for each respective audio data sample of the test subset.

4. The computer-implemented method of claim 1, wherein training the keyword detection model comprises maximizing a second loss between the keyword enrollment embedding and the corresponding nonmatching keyword test embedding determined for reach respective audio data sample of each of the other sets of utterances.

5. The computer-implemented method of claim 1, wherein the audio data samples comprise at least one of:
non-synthetic audio data samples; or
synthetic audio data samples.

6. The computer-implemented method of claim 1, wherein each audio data sample of the respective one of the sets of utterances comprises speech characteristics speaking the corresponding utterance different than at least one other audio data sample of the respective one of the sets of utterances.

7. The computer-implemented method of claim 1, wherein, for the respective one of the sets of utterances, the operations further comprise:
assigning one or more audio data samples from the respective one of the sets of utterances to the enrollment subset; and
assigning each other audio data sample from the respective one of the sets of utterances not assigned to the enrollment subset to the test subset.

8. The computer-implemented method of claim 1, wherein the corresponding utterance of each respective set of utterances comprises a user-defined custom keyword.

9. The computer-implemented method of claim 1, wherein:
determining the keyword enrollment embedding comprises determining the keyword enrollment embedding using an encoder of the keyword detection model; and
determining the corresponding matching keyword test embedding comprises determining the corresponding matching keyword test embedding using the encoder of the keyword detection model.

10. The computer-implemented method of claim 9, wherein the encoder comprises a plurality of multi-head attention layers.

11. A system comprising:
data processing hardware; and
memory hardware in communication with the data processing hardware, the memory hardware storing instructions that when executed on the data processing hardware cause the data processing hardware to perform operations comprising.
receiving a plurality of sets of utterances, each respective set of utterances comprising audio data samples of a corresponding utterance different than the corresponding utterance of each other set of utterances of the plurality of sets of utterances;
for a respective one of the sets of utterances:
determining a keyword enrollment embedding for an enrollment subset of the audio data samples of the respective one of the sets of utterances; and
for each respective audio data sample of a test subset of the audio data samples of the respective one of the sets of utterances, determining a corresponding matching keyword test embedding;
for each respective audio data sample of each of the other sets of utterances, determining a corresponding nonmatching keyword test embedding; and
training a keyword detection model to detect a presence of a custom keyword in spoken audio based on the keyword enrollment embedding, the corresponding matching keyword test embedding determined for each respective audio data sample of the test subset, and the corresponding nonmatching keyword test embedding determined for each respective audio data sample of each of the other sets of utterances.

12. The system of claim 11, wherein determining the keyword enrollment embedding for the enrollment subset of the audio data samples comprises:
for each respective audio data sample of the enrollment subset, determining a corresponding keyword enrollment embedding; and
determining a centroid keyword enrollment embedding based on the corresponding keyword enrollment embedding determined for each respective audio data sample of the enrollment subset.

13. The system of claim 11, wherein training the keyword detection model comprises minimizing a first loss between the keyword enrollment embedding and the corresponding matching keyword test embedding determined for each respective audio data sample of the test subset.

14. The system of claim 11, wherein training the keyword detection model comprises maximizing a second loss between the keyword enrollment embedding and the corresponding nonmatching keyword test embedding determined for reach respective audio data sample of each of the other sets of utterances.

15. The system of claim 11, wherein the audio data samples comprise at least one of:
non-synthetic audio data samples; or
synthetic audio data samples.

16. The system of claim 11, wherein each audio data sample of the respective one of the sets of utterances comprises speech characteristics speaking the corresponding utterance different than at least one other audio data sample of the respective one of the set of utterances.

17. The system of claim 11, wherein, for the respective one of the set of utterances, the operations further comprise:
assigning one or more audio data samples from the respective one of the sets of utterances to the enrollment subset; and
assigning each other audio data sample from the respective one of the sets of utterances not assigned to the enrollment subset to the test subset.

18. The system of claim 11, wherein the corresponding utterance of each respective set of utterances comprises a user-defined custom keyword.

19. The system of claim 11, wherein:
determining the keyword enrollment embedding comprises determining the keyword enrollment embedding using an encoder of the keyword detection model; and
determining the corresponding matching keyword test embedding comprises determining the corresponding matching keyword test embedding using the encoder of the keyword detection model.

20. The system of claim 19, wherein the encoder comprises a plurality of multi-head attention layers.
